(19) United States
(12) Patent Application Publication
(10) Pub. No.: US 2026/0029894 A1
(43) Pub. Date: Jan. 29, 2026

(54) SYSTEMS AND METHODS FOR GENERATING GOAL-BASED ACTION SETS

(71) Applicant: Wells Fargo Bank, N.A., San Francisco, CA (US)

(72) Inventors: David Furst, St. Louis, MO (US); Justin Morris Krieger, St. Louis, MO (US)

(21) Appl. No.: 18/786,019

(22) Filed: Jul. 26, 2024

(51) Int. Cl. G06F 3/0482

(52) U.S. Cl. CPC G06F 3/0482

(57) ABSTRACT

Systems, apparatuses, methods, and computer program products are disclosed for generating goal based action sets. An example method includes receiving, by communications hardware, a goal dataset comprising a plurality of user-selected goals including a first user-selected goal. The example method also includes determining, by an action mapping engine, an action dataset comprising a plurality of actions to be performed by a user to achieve the first user-selected goal, wherein the plurality of actions are ranked according to a first prioritization. The example method also includes determining, by a rules engine, a second prioritization for the plurality of actions based at least on a user dataset associated with the user. The example method also includes causing, by the communications hardware and via a first graphical user interface view, presentation of the plurality of actions according to the second prioritization.

### BACKGROUND

Computer-implemented recommendation systems may be utilized to seek advice or coaching to identify and pursue life goals including financial goals. However, a recommendation system's failure to incorporate an appropriate scope of a user's financial outlook can result a variety of substantial technical issues, such as misallocated resources, increased risk exposure, and regulatory compliance problems.

### BRIEF SUMMARY

A system that provides financial advice or recommendations to a person in service of financial and/or life goals may be limited by a lack of information regarding prioritization of those goals by the person. For example, these types of systems often operate under the assumption of equal importance among goals. However, financial and/or life aspirations of a person are typically hierarchical and influenced by values, personal circumstances, and short and long-term considerations. Without a nuanced understanding of a person's priorities, a system may suggest actions that (while sound in theory) fail to align with overarching objectives of the person. This may lead to suboptimal outcomes and a sense of disconnection between the system's recommendations and the person's expectations.

Additionally, many existing systems that provide financial advice often prioritize the sale of financial products over genuinely assisting people in achieving financial and/or life goals. Consequently, recommendations may be skewed toward offerings that maximize profitability for a provider of the system rather than the most optimal outcome for the person.

Further, existing systems also fail to incorporate other relevant user data when prioritizing actions to service goals. For example, while basic financial information and defined objectives may be considered, these systems lack sophistication to account for broader contextual factors such as life events, economic conditions, and/or evolving personal circumstances. Consequently, recommendations output by these systems may not adequately reflect real-time needs and priorities of its users.

Existing systems also typically lack intelligence to effectively listen to users when they indicate that a recommendation is not needed or desired. For example, despite user feedback indicating a lack of relevance or immediate necessity, systems may still push the same recommendation (e.g., at a later time), causing frustration and/or disengagement on the part of the user. Failure of these systems to adapt to user input undermines trust in the system and causes users to be less inclined to engage with the system in the future.

Additionally, existing systems often lack the capability for other users such as financial advisors, bankers, or the like to modify output of the system for particular users. For example, while existing systems may provide a standardized set of recommendations, they offer limited flexibility for personal financial advisors or other authorized users to tailor recommendations to specific needs or preferences of individual clients.

In contrast to these existing systems and conventional techniques, example embodiments described herein provide a planning, advice, and execution (PAE) system that generates goal-based action sets tailored to each user's unique circumstances, preferences, and priorities. The PAE system may dynamically adapt and learn from user interactions and refine recommended actions and corresponding priority of the recommended actions in real-time to better serve evolving needs of users. The PAE system fosters deep user engagement, trust, and more accurate output for users by prioritizing customization, responsiveness, and user empowerment. Moreover, the PAE system described herein allows for seamless collaboration between users and financial advisors, enabling advisors to customize recommendations and strategies based on specific client needs, while at the same time providing an element of transparency and accountability lacking in existing systems through enabling a digital audit trail of financial advice shared between financial advisors and clients. This level of documentation is invaluable for regulatory compliance and enables regulatory bodies to easily review and verify advice provided to clients to ensure that the advice aligns with established standards.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1A illustrates an example operating environment for a planning, advice, and execution (PAE) system in accordance with some example embodiments described herein.

FIG. 1B illustrates various aspects of a PAE system in conjunction with a user device in accordance with some example embodiments described herein.

FIG. 2 illustrates a schematic block diagram of example circuitry embodying a system device that may perform various operations in accordance with some example embodiments described herein.

FIG. 3 illustrates an example flowchart for generating goal-based action sets, in accordance with some example embodiments described herein.

FIG. 4 illustrates an example flowchart for modifying prioritization of actions in response to user interaction, in accordance with some example embodiments described herein.

FIG. 5 illustrates an example flowchart for modifying prioritization of actions in response to at least one advisor-selected action, in accordance with some example embodiments described herein.

FIG. 6 illustrates an example user interface used in some example embodiments described herein.

FIG. 7 illustrates an example user interface used in some example embodiments described herein.

FIG. 8 illustrates an example user interface used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “action” as used herein refers to a specific task, service, or tool that can be employed to advance towards a defined goal. In other words, actions may be suggested tangible steps a user may take to make progress towards one or more of their goals. In some embodiments, actions may be determined and prioritized qualitatively by evaluating alignment of the actions with overlapping goals and their impact on those goals, as well as other inputs (e.g., user feedback) as discussed herein. In various embodiments, actions may be suggested and delivered digitally via a digital platform (e.g., PAE system and corresponding system application as discussed below). In various example embodiments, actions are prioritized and presented in a manner based on the prioritization to ensure that the most critical or impactful actions are performed first, allowing for a user to systematically complete objectives and optimize their resource allocation.

In various embodiments, actions may include content actions, tool actions, service actions, people actions, product actions, and goal actions. In some embodiments, content actions may include, for example, suggested content for a user to digest in service of a goal. For example, content actions may include reading an article, listening to one or more episodes of a podcast, viewing a video, reading a guide, attending a seminar, and/or the like. In various embodiments, a specific piece of content may be determined to be included in an action dataset (e.g., a plurality of determined actions for one or more goals) based on its relevance to one or more goals. In various embodiments, tool actions may include, for example, suggested tools (e.g., software tools offered by a financial institution and/or a third-party platform) for a user to utilize in service of a goal. For example, tool actions may include utilizing a retirement tool (e.g., for estimating years until retirement and/or required savings for retirement), an education calculator tool, a debt optimizer tool, a mortgage calculator tool, and/or the like. In various embodiments, a specific tool may be determined to be included in an action dataset based on its relevance to one or more goals.

In some embodiments, service actions may include, for example, suggested services for a user to utilize in service of a goal. For example, service actions may include setting up auto-transfer for one or more bank accounts, enrolling in credit monitoring services, configuring alerts for one or more accounts (e.g., low balance alerts, fraud alerts, etc.), pre-qualification services (e.g., pre-qualifying for certain instruments such as loans or the like), setting up auto-pay (e.g., for various bills, loans, etc.), and/or the like. In various embodiments, a specific service may be determined to be included in an action dataset based on its relevance to one or more goals.

In some embodiments, people actions may include, for example, suggested individuals for a user to communicate or interact with in service of a goal. For example, people actions may include communicating with and/or receiving advice from a premier banker, mortgage consultant, small business banker, personal banker, financial advisor, and/or the like. In various embodiments, communication with a specific individual may be determined to be included in an action dataset based on its relevance to one or more goals.

In some embodiments, product actions may include, for example, suggested products (e.g., products offered by a financial institution) for a user to obtain and/or utilize in service of a goal. For example, product actions may include obtaining banking products (e.g., debit card, etc.), credit products (e.g., credit cards, etc.), lending products (e.g., loans, mortgages, etc.), investment products, and/or the like. In various embodiments, a specific product may be determined to be included in an action dataset based on its relevance to one or more goals.

In some embodiments, goals actions may include, for example, suggested goals for a user to define or pursue based on one or more other goals. For example, goal actions may include creating a specific financial goal (e.g., saving for a child's college tuition) and/or the like. In various embodiments, creation of a specific goal may be determined to be included in an action dataset based on its relevance to one or more goals and/or actions.

### System Architecture

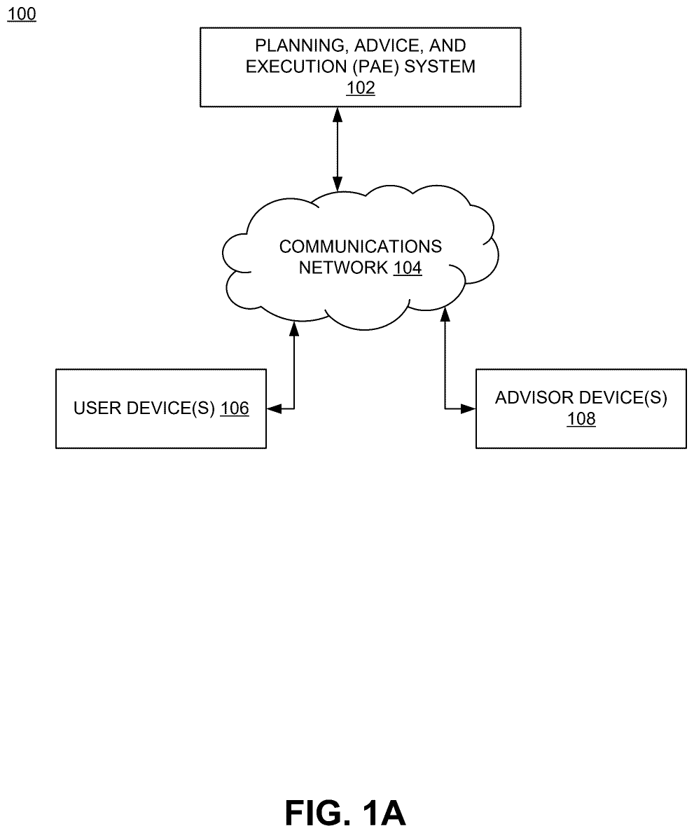

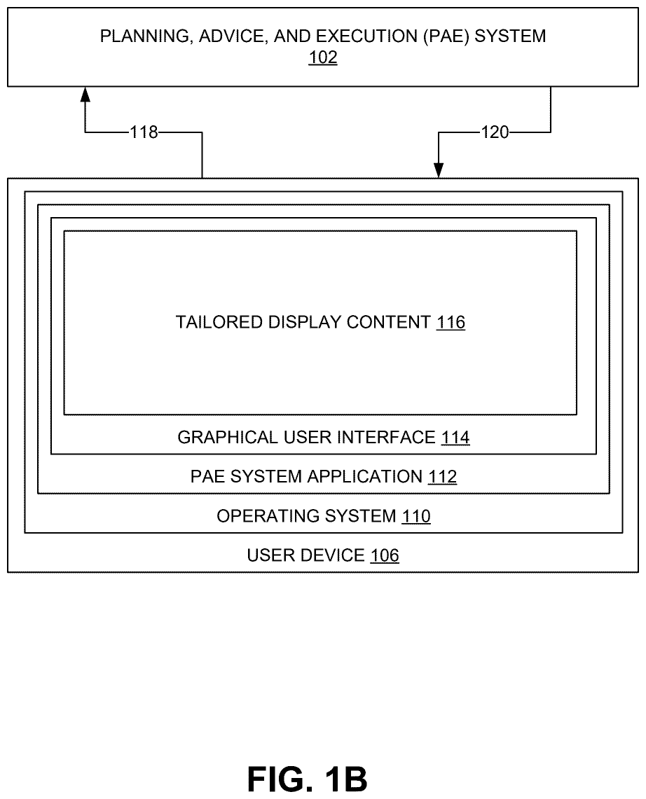

Example embodiments described herein may be implemented using any of a variety of computing devices or servers. To this end, FIG. 1A illustrates an example environment 100 within which various embodiments may operate. As illustrated, an planning, advice, and execution (PAE) system 102 may receive and/or transmit information via communications network 104 (e.g., the Internet) with any number of other devices, such as one or more of user devices 106 and advisor devices 108.

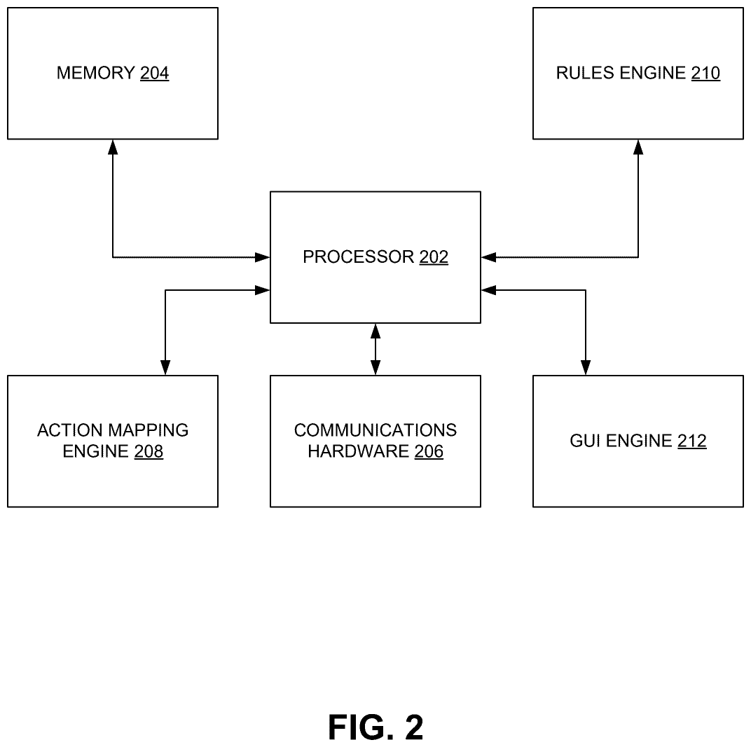

The PAE system 102 may be implemented as one or more computing devices or servers, which may be composed of a series of components. The PAE system 102 may include, or be implemented on, one or more computing devices utilized in providing aspects of a PAE experience, such as one or more servers, cloud services, data stores, and the like. Particular components of the PAE system 102 are described in greater detail below with reference to apparatus 200 in connection with FIG. 2.

The one or more user devices 106 and the one or more advisor devices 108 may be embodied by any computing devices known in the art. For example, user devices 106 and/or advisor devices 108 may include one or more of a mobile phone, a smart phone, a smart watch, a desktop computer, a laptop computer, a tablet, a virtual or augmented reality headset, an internet of things (IOT) device, a vehicle infotainment system, an automated teller machine, a point of sale (POS) device, an interactive kiosk, and the like. The one or more user devices 106 and the one or more advisor devices 108 need not themselves be independent devices, but may be peripheral devices communicatively coupled to other computing devices. In various embodiments, the PAE system 102 (and corresponding PAE system application 112 discussed below in connection with FIG. 1B) may be managed or otherwise facilitated by a financial institution (e.g., a bank). In such embodiments, user devices 106 may correspond to devices of users (i.e., customers of the bank) and advisor devices 108 may correspond to devices of advisors (i.e., employees or affiliates of the bank, such as financial advisors, bankers, tellers, and/or the like). In various embodiments, users and advisors may interact with the PAE system 102 through different versions of a PAE system application 112. For example, user devices 106 may engage with a customer-facing iteration of the PAE system application 112 tailored to meet needs of users, while advisor devices 108 may engage with an advisor-facing iteration of the PAE system application 112 designed to enable advisors to deliver tailored financial guidance and support to users (as discussed further herein).

FIG. 1B illustrates various aspects of a PAE system 102 in conjunction with an example user device 106 according to one or more embodiments of the current disclosure. Generally, the PAE system 102 may provide customized experience data 120 to user device 106 to cause tailored display content 116 to be presented via one or more views of the graphical user interface (GUI) 114 of user device 106. In many embodiments, the customized experience data 120 may be generated by PAE system 102 based at least in part on feedback data 118 received from the user device 106. The user device 106 may include a PAE system application 112 accessible via an operating system 110 of the user device 106. The PAE system application 112 may generate the tailored display content 116 on GUI 114 based on the customized experience data 120. In various embodiments, the PAE system application 112 may be installed by a user. It will be appreciated that in various embodiments the PAE system application 112 may not be necessary to view the tailored display content 116. For example, the tailored display content 116 may be viewed via another application, such as a web browser. Accordingly, in some embodiments, the PAE experience may include a web-based experience.

One or more advisor interfaces may operate in a similar manner to enable advisors to interact with the PAE system 102 and/or users as described herein. Some embodiments may include a plurality of PAE system applications. For instance, as discussed above, separate PAE system applications may be provided for users and advisors.

The user device 106 may be associated with a user of the PAE system 102. In some embodiments, the user device 106 may be associated with a user of the PAE system 102 based on login credentials provided to the PAE system application 112. Accordingly, in various embodiments, feedback data 118 may include login credentials. More generally, feedback data 118 may include any data sent by the user device 106 to the PAE system 102.

### Example Implementing Apparatuses

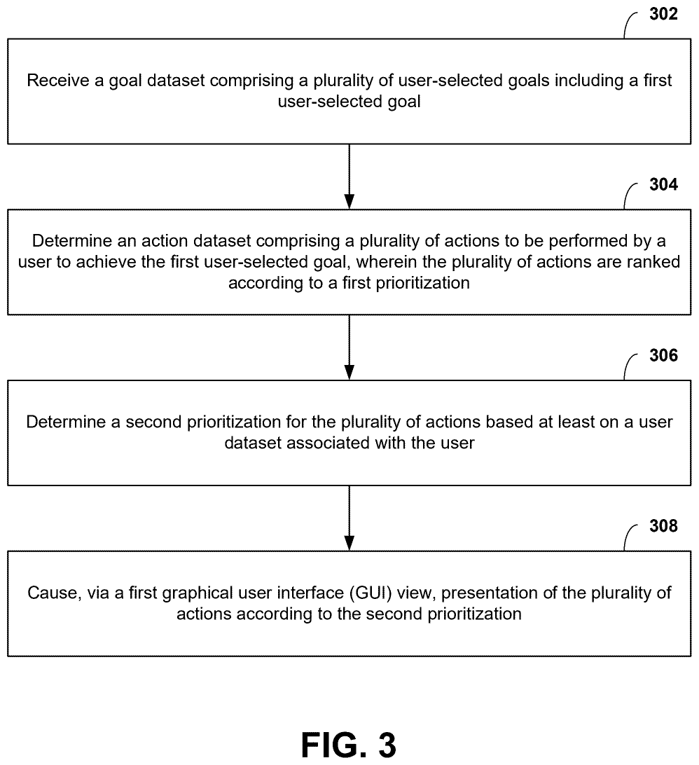

The PAE system 102 (described previously with reference to FIG. 1A) may be embodied by one or more computing devices or servers, shown as apparatus 200 in FIG. 2. The apparatus 200 may be configured to execute various operations described above in connection with FIG. 1A and below in connection with FIGS. 3-5. As illustrated in FIG. 2, the apparatus 200 may include processor 202, memory 204, communications hardware 206, action mapping engine 208, rules engine 210, and graphical user interface (GUI) engine 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises an action mapping engine 208 that maps a plurality of actions to one or more goals. The action mapping engine 208 may utilize processor 202, memory 204, or any other hardware component included in the apparatus 200 to perform these operations, as described in connection with FIGS. 3-5 below. The action mapping engine 208 may further utilize communications hardware 206 to gather data from a variety of sources (e.g., user device(s) 106 and/or advisor device(s) 108, as shown in FIG. 1A), and/or exchange data with a user, and in some embodiments may utilize processor 202 and/or memory 204 to determine an action dataset comprising a plurality of actions to be performed by a user to achieve a goal.

In various embodiments, action mapping engine 208 may employ a database (e.g., stored in memory 204) of predefined actions that are associated with predefined goals. In some embodiments, each action may be tagged with metadata describing relevance of the action to one or more particular predefined goals. The action mapping engine 208 may also employ a heuristic prioritization to rank predefined actions based on relevance and/or effectiveness of achieving a given goal. That is, each goal may be associated with a plurality of actions ranked according to a first prioritization that is a heuristic prioritization. The first prioritization may be an “initial” prioritization of actions which may later be re-prioritized based on additional user data and/or user interactions with the PAE system 102. In various embodiments, certain actions may be mapped to multiple goals.

In addition, the apparatus 200 further comprises a rules engine 210 that determines updated prioritizations of actions based on a user dataset and/or one or more selection indications. The rules engine 210 may utilize processor 202, memory 204, or any other hardware component included in the apparatus 200 to perform these operations, as described in connection with FIGS. 3-5 below. The rules engine 210 may further utilize communications hardware 206 to gather data from a variety of sources (e.g., user device(s) 106 and/or advisor device(s) 108, as shown in FIG. 1A), and/or exchange data with a user, and in some embodiments may utilize processor 202 and/or memory 204 to determine updated prioritizations for action sets.

Further, the apparatus 200 further comprises a GUI engine 212 that dispositions GUI views and modifies GUI elements based on user input. The GUI engine 212 may utilize processor 202, memory 204, or any other hardware component included in the apparatus 200 to perform these operations, as described in connection with FIGS. 3-5 below. The GUI engine 212 may further utilize communications hardware 206 to gather data from a variety of sources (e.g., user device(s) 106 and/or advisor device(s) 108, as shown in FIG. 1A), and/or exchange data with a user, and in some embodiments may utilize processor 202 and/or memory 204 to disposition and/or modify one or more GUI elements.

Although components 202-212 are described in part using functional language, it will be understood that the particular implementations necessarily include the use of particular hardware. It should also be understood that certain of these components 202-212 may include similar or common hardware. For example, the action mapping engine 208, rules engine 210, and GUI engine 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “engine” with respect to elements of the apparatus therefore shall be interpreted as necessarily including the particular hardware configured to perform the functions associated with the particular element being described. Of course, while the term “engine” should be understood broadly to include hardware, in some embodiments, the term “engine” may in addition refer to software instructions that configure the hardware components of the apparatus 200 to perform the various functions described herein.

Although the action mapping engine 208, rules engine 210, and GUI engine 212 may leverage processor 202, memory 204, or communications hardware 206 as described above, it will be understood that any of action mapping engine 208, rules engine 210, and GUI engine 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that action mapping engine 208, rules engine 210, and GUI engine 212 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of flowcharts and graphical user interfaces.

### Example Operations

Turning to FIGS. 3-5, example flowcharts are illustrated that contain example operations implemented by example embodiments described herein. The operations illustrated in FIGS. 3-5 may, for example, be performed by a system device of the PAE system 102 shown in FIG. 1A, which may in turn be embodied by an apparatus 200, which is shown and described in connection with FIG. 2. To perform the operations described below, the apparatus 200 may utilize one or more of processor 202, memory 204, communications hardware 206, action mapping engine 208, rules engine 210, and GUI engine 212, and/or any combination thereof. It will be understood that user interaction with the PAE system 102 may occur directly via communications hardware 206, or may instead be facilitated by a separate client device, such as a user device 106 or advisor device 108 as shown in FIG. 1A, and which may have similar or equivalent physical componentry facilitating such user interaction.

Turning first to FIG. 3, example operations are shown for generating goal-based action sets.

As shown by operation 302, the apparatus 200 includes means, such as processor 202, memory 204, communications hardware 206, and/or the like, for receiving a goal dataset comprising a plurality of user-selected goals including a first user-selected goal. In various embodiments, PAE system 102 may deliver a customer-facing iteration of the PAE system application 112 to a user device 106. In this manner, a user may interact with the PAE system application 112 to select one or more goals relevant to them. For example, the PAE system application 112 may be a component of or otherwise associated with a mobile banking application managed by a financial institution, and the PAE system application 112 may allow for users to interact with an advice, planning, and attainment experience that focuses on understanding clients as human beings and what they want to accomplish with their life. In this regard, the PAE system 102, or one or more components thereof, may operate to provide technology-based solutions that continuously sync financial objectives with aspirations and values through the many moments of life. These technology-based solutions may empower humans to make financial decisions and attain life objectives, big or small, simple, or complex, that make a real and lasting impact on their lives and future generations. Through system application 112, a user may interact with elements of the application to identify and assign goals to themselves.

A goal dataset may comprise a structured collection of electronic data corresponding to one or multiple user-selected goals (e.g., financial objectives and the like) for a given user. In various embodiments, a goal dataset may be received by PAE system 102 via communications hardware 206 through transmission over communications network 104 from a user device 106. In various embodiments, a goal dataset may include data about each user-selected goal, such as goal identifiers (e.g., unique codes corresponding to predefined goals), target amounts, timing information, user-defined priority, and the like. In various embodiments, a goal dataset may include metadata regarding each user-selected goal, such as a user identifier, timestamps associated with a time and/or date of user selection of the goal, goal-specific parameters, and the like.

In various embodiments, when defining goals via the system application 112, users may have the capability to assign a priority to each selected goal. In this regard, users can effectively rank their goals based on personal significance or urgency. In some embodiments, users may assign priority levels through, for example, categorical labels (e.g., high priority, medium priority, low priority) or more granular criteria such as through a weighted scoring system or numerical ranking system. In this manner, priority indicators for each user-selected goal may be generated based on a user-defined prioritization of the plurality of user-selected goals. These priority indicators may be included in the goal dataset.

As shown by operation 304, the apparatus 200 includes means, such as processor 202, memory 204, action mapping engine 208, and/or the like, for determining an action dataset comprising a plurality of actions to be performed by a user to achieve the first user-selected goal. To determine an action dataset for a given goal, the action mapping engine may reference a database (e.g., stored in memory 204) of predefined actions that are mapped to predefined goals. In some embodiments, each action may be tagged with metadata describing relevance of the action to one or more particular predefined goals. In such a mapping, each goal may be linked to one or more actions in a particular heuristic priority. As noted above, some actions may be mapped to multiple goals, while some actions may be mapped to only a single goal based on relevance. For instance, an action of establishing an emergency savings fund may be applicable to a wide variety of financial goals, and thus the action may be mapped to multiple goals. Table A provides an example of this overlapped mapping, where three distinct goals are mapped to various actions.

TABLE A

| Goal | Action(s) |
|---|---|
| Goal A | Action A, Action B, Action C |
| Goal B | Action A, Action C, Action D |
| Goal C | Action E, Action F, Action B |

In various embodiments, the plurality of actions mapped to a given goal may be ranked according to a first prioritization. As discussed above, the action mapping engine 208 may employ a heuristic, predefined prioritization to rank predefined actions based on relevance and/or effectiveness of achieving a given goal. For example, each goal may be associated with a plurality of actions ranked according to a first prioritization that is a heuristic prioritization.

In some example embodiments, the heuristic prioritization may be predetermined based on input from expert guidance, such as input from a plurality of experienced financial advisors, bankers, and/or other qualified individuals in similar positions. In this manner, bias may be eliminated in that initial priority is not based on specific users, but rather a general financial advice framework which experts deem applicable to all users.

The first prioritization may be an initial or base prioritization of actions (which may later be continuously re-prioritized based on additional user data and/or user interactions with the PAE system). For example, as shown in Table A, Goal A may require that Actions A, B, and C be performed in that order, while goal C may require that Actions E and F be performed first, followed by Action B.

In some embodiments, determining the action dataset may comprise determining a global action list. In this regard, the apparatus 200 includes means, such as processor 202, memory 204, action mapping engine 208, rules engine 210, and/or the like, for determining a global action list. In various embodiments, a global action list may be determined based on an intersection of the user's user-defined prioritization of the plurality of user-selected goals in the goal dataset and the heuristically prioritized actions corresponding to each of the user-selected goals as identified by action mapping engine 208. For example, in some embodiments, a weighted approach may be taken to determine the global action list, wherein heuristic weights (i.e., weighted values) are assigned to each action of a respective goal and subsequently adjusted based on user-defined priority of a given goal. For example, the heuristic weight may be multiplied by a scaling factor derived from the goal's user-defined priority. In this regard, actions associated with goals which the user views as high-priority may have their associated weights increased, while those with low-priority may be decreased. For actions which are mapped to multiple goals, an overall score may be calculated by aggregating (e.g., summing or averaging) corresponding weights from the goals that the action is mapped to. The plurality of actions across goals may then be ranked based on their final scores (e.g., in descending order) into a global action list. In some embodiments, the global action list may be further processed to eliminate duplicates (e.g., duplicate actions corresponding to multiple goals) and break ties where appropriate.

As shown by operation 306, the apparatus 200 includes means, such as processor 202, memory 204, action mapping engine 208, rules engine 210, and/or the like, for determining a second prioritization for the plurality of actions based at least on a user dataset associated with the user. In various embodiments, rules engine 210 may evaluate each action (e.g., in a global action list) against a set of predefined rules in order to re-prioritize actions, which may include removing, adding, or re-ranking actions within the global action list.

In various embodiments, when determining the second prioritization, rules engine 210 may refer to a user dataset associated with a user for which the global action list was generated. A user dataset may comprise a user's personal financial information and additional data maintained by a financial institution (e.g., a financial institution managing or otherwise associated with the PAE system 102). For example, a user dataset may comprise financial data specific to the user such as income, expenses, assets, liabilities, credit score history, investment portfolio(s), payment history, transaction history, checking account and/or savings account deposit and withdrawal history, and the like. A user dataset may also comprise demographic data about the user, such as age, employment status, citizenship information, and other identifying information.

In various example embodiments, rules engine 210 may integrate with backend components of PAE system 102 to interface with one or more databases that store user datasets, goal datasets, and/or global action lists. In various embodiments, the rules engine 210 may utilize an Application Programming Interface (API) to retrieve input data such as user datasets, goal datasets, and/or global action lists in order to determine priority of actions.

In various embodiments, determining a second prioritization for the plurality of actions may comprise determining that one or more actions are to be removed from the global action list. In this regard, the apparatus 200 includes means, such as processor 202, memory 204, rules engine 210, or the like, for determining one or more actions are to be removed from the global action list and for removing the one or more actions from the global action list. For example, rules engine 210 may comprise a rule that an action directed to establishing an emergency savings fund be removed in the event that it is determined that the user already has a savings account storing funds that meet a minimum threshold associated with the action. As another example, an action to invest in a high-risk asset may be excluded based on the user dataset indicating a more risk-adverse investment history.

In various embodiments, determining a second prioritization for the plurality of actions may comprise determining that one or more actions are to be added to the global action list. In this regard, the apparatus 200 includes means, such as processor 202, memory 204, rules engine 210, or the like, for determining one or more actions are to be added to the global action list and for adding the one or more actions to the global action list. For example, rules engine 210 may comprise a rule that an action directed to creating a budget be added in in response to determining that the user's transaction history indicates reckless discretionary spending combined with little savings.

As shown by operation 308, the apparatus 200 includes means, such as processor 202, memory 204, communications hardware 206, GUI engine 212, or the like, for causing via a first graphical user interface (GUI) view, presentation of the plurality of actions according to the second prioritization. For instance, the PAE system 102, via communications hardware 206, may securely transmit a payload containing the global action list (in an order according to the second prioritization) to a user device 106, and system application 112 of user device 106 may then parse the payload and update a GUI view of the system application 112 to display the global action list, allowing a user to interact with each separate action. As discussed below, user interactions with the global action list may be sent back to the PAE system 102 to modify the action list to provide a seamless financial planning and goal progress user experience. In some embodiments, the plurality of actions are presented via the first GUI as interactive GUI elements.

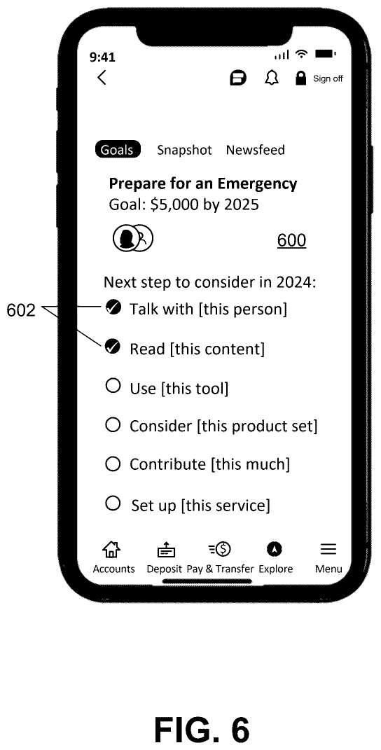

In various embodiments, the GUI view may display the entire global action list (e.g., actions pertaining to all goals) or alternatively may display specific actions based on a selected goal. For example, system application 112 may enable a user to drill down into specific goals, allowing for selection of a goal and display of prioritized actions associated with the specific selected goal. An example of such a display is shown in FIG. 6, wherein a GUI view 600 for a “Prepare for an Emergency” goal displays a prioritized listing of six example actions to be performed in service of that goal.

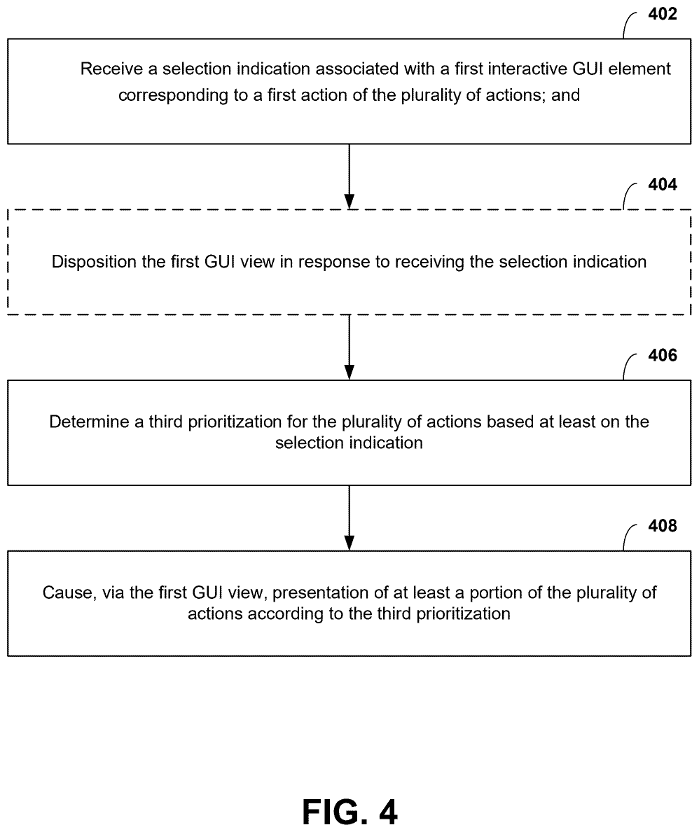

As mentioned above, actions may be further modified based on user interactions within system application 112. Turning to FIG. 4, example operations are shown for modifying prioritization of actions in response to user interaction.

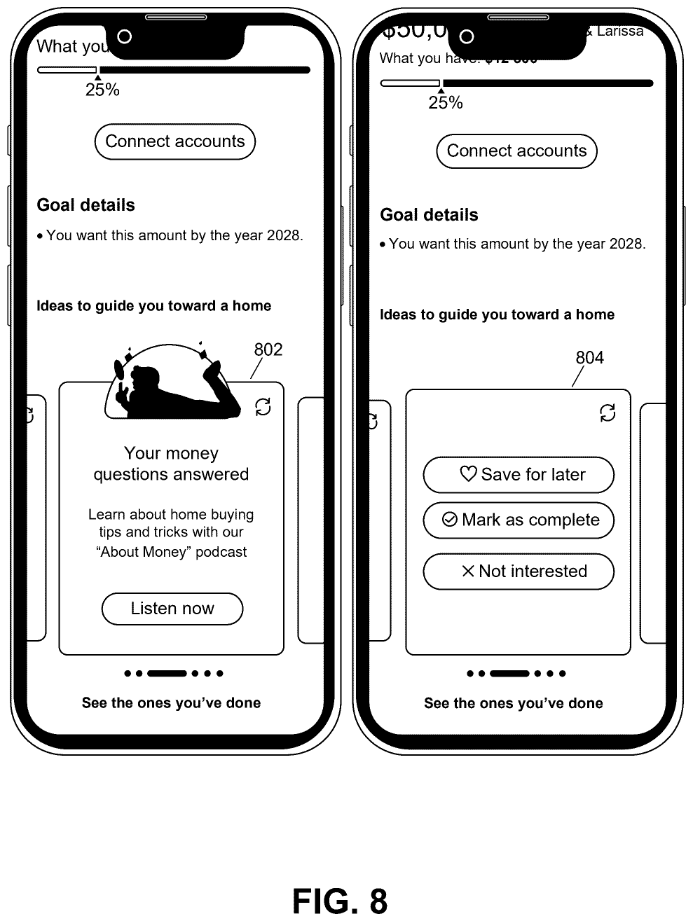

As shown by operation 402, the apparatus 200 includes means, such as processor 202, memory 204, communications hardware 206, GUI engine 212, or the like, for a selection indication associated with a first interactive GUI element corresponding to a first action of the plurality of actions. In this regard, each action in a given listing of actions presented via system application 112 may be a separate GUI element that is interactive (e.g., able to be selected, toggled, expanded, collapsed, adjusted (e.g., a slider), clicked, swiped, pinched, tapped, long-pressed, or the like) such that a user may provide feedback regarding the action in some form via a touchscreen or peripheral device (e.g., a mouse) of user device 106. A selection indication may be received in response to a user interacting with a GUI element corresponding to an action in some manner. As shown for example in FIG. 8, a user may select a UI element 802 corresponding to an action (e.g., listening to a podcast) to cause visual presentation of options 804 related to the action, such as, for example to bookmark the action (e.g., “save for later”), mark the action as complete, or dismiss the action (e.g., “not interested”).

As shown by operation 404, the apparatus 200 includes means, such as processor 202, memory 204, communications hardware 206, GUI engine 212, or the like, for dispositioning the first GUI view in response to receiving the selection indication. For instance, user interaction with a GUI element corresponding to an action may trigger a dynamic visual change to the GUI element, such as adding or removing features of the GUI element, modifying the GUI element (e.g., changing text and/or images), removing the GUI element from the GUI view altogether, or the like. In some embodiments, the manner in which the GUI element is interacted with may determine how the GUI element is dispositioned. For example, swiping right on the GUI element may mark the first action as complete, while swiping left or performing another gesture (e.g., tapping, swiping up or down, etc.) may cause the GUI element to be dispositioned in a different manner.

In some embodiments, a user may interact with the interactive GUI element corresponding to the first action to mark the action as complete. In this regard, the selection indication may correspond to a completion of the first action. In this instance, the GUI engine 212 may disposition the first GUI view by modifying the GUI element that corresponds to the first action to include an image indicating completion (e.g., a check mark 602, as shown in FIG. 6, or similar image). In this regard, in some embodiments, the selection indication may correspond to a completion of the first action, and the GUI engine may disposition the first GUI view by modifying the first interactive GUI element to visually indicate the completion of the first action.

In some embodiments, a user may interact with the interactive GUI element corresponding to the first action to dismiss the first action as irrelevant. In this regard, the selection indication may correspond to a determination by the user that the first action is irrelevant to reaching the associated goal. This may stem from, for example, the user already having completed the first action (information which was not provided to PAE system 102 via a user dataset) or the user more simply not deeming the first action to be worthwhile (e.g., the user is already knowledgeable about subject matter of a suggested podcast). In this instance, the GUI engine 212 may disposition the first GUI view by modifying the GUI element that corresponds to the first action to include an image indicating its irrelevance or, in some embodiments, removing the GUI element from the list of actions. In some embodiments, the GUI element may be removed from the first GUI view altogether, moved to the bottom of the action list, or modified to include an image indicating its irrelevance and moved to the bottom of the action list. In this regard, in some embodiments, the selection indication may correspond to a dismissal of the first action, and the GUI engine may disposition the first GUI view by removing the first interactive GUI element from the first GUI view.

In some embodiments, a user may interact with the interactive GUI element corresponding to the first action to bookmark the first action. In this regard, the selection indication may correspond to a bookmarking of the first action. In some embodiments, a user may bookmark an action to remind themselves to perform the action soon. In this instance, the GUI engine 212 may disposition the first GUI view by modifying the GUI element that corresponds to the first action to include an image indicating bookmarking of the action (e.g., highlighting the GUI element a different color, including an image depicting a bookmark, and/or the like). In this regard, in some embodiments, the selection indication may correspond to a bookmarking of the first action, and the GUI engine may disposition the first GUI view by modifying the first interactive GUI element to visually indicate the bookmarking of the first action.

In some embodiments, a user may interact with the interactive GUI element corresponding to the first action to view additional information about the action and/or goal associated with the action. In this regard, the apparatus 200 includes means, such as processor 202, memory 204, communications hardware 206, or the like, for causing presentation of a second GUI view including at least one of text, audio, or video regarding the first action of the plurality of actions. For instance, tapping or clicking on an interactive GUI element corresponding to the first action may cause the system application 112 to present a second GUI view that includes information about the action and/or goal, such as, for example, text detailing the action and/or how it relates to the goal, one or more playable audio and/or video files (e.g., a podcast recording in audio or video, an information video about financial information related to the action and/or goal, and/or the like). In some instances, the second GUI view may comprise a third-party webpage presented through system application 112.

As shown by operation 406, the apparatus 200 includes means, such as processor 202, memory 204, rules engine 210, or the like, for determining a third prioritization for the plurality of actions based at least on the selection indication. In this regard, based on the selection indication (e.g., how the user has altered the status or details of an action or multiple actions) the PAE system 102 may dynamically generate a new prioritization of actions. For example, when a user completes, bookmarks, and/or dismisses an action, the system application 112 may update the underlying user dataset and/or action dataset and synchronize these updates with PAE system application 112 (e.g., via communications hardware 206). In some embodiments, rules engine 210 may then process the updates to reassess the priority and relevance of the remaining actions, which may involve determining and applying new weights to each action. In this manner, rules engine 210 may then determine a revised action list that is reordered to reflect current priorities of the user. The updated action list may then be transmitted back to the user device 106, which is then integrated into the GUI of system application 112. In this regard, as shown by operation 408, the apparatus 200 includes means, such as processor 202, memory 204, communications hardware 206, GUI engine 212, or the like, for causing, via the first GUI view, presentation of at least a portion of the plurality of actions according to the third prioritization.

In various embodiments, the user may continue to interact with the presented plurality of actions (e.g., as actions are completed) such that the PAE system 102 may continuously and dynamically update prioritization of the actions. In some embodiments, PAE system 102 may automatically detect when actions should be modified and provide suggestions to the user in real-time. For example, PAE system 102 may continuously receive updates to the user's user dataset (e.g., through linked financial institution databases or the like) and provide these updates along with a current action dataset for the user as inputs to the rules engine 210 to determine if one or more actions are to be added, removed, or otherwise modified. For example, if the user has opened and funded a savings account (e.g., as detected through an updated user dataset), the PAE system 102 may recognize this change and provide a suggestion (e.g., visually present a suggestion through system application 112) to mark an “establish an emergency savings fund” action as complete. As a result of this real-time user data detection, outdated or redundant actions are flagged, such that the PAE system 102 ensures that the action list for a user is consistently relevant and tailored to the user's evolving financial situation and goals.

As mentioned earlier, in various embodiments, the PAE system 102 may allow for seamless collaboration between users (e.g., bank customers) and financial advisors (as well as other qualified bank personnel) to enable advisors to customize recommendations and strategies based on specific client needs. Several benefits are realized through this feature. For instance, an element of transparency and accountability (lacking in existing systems) is provided through enabling a digital audit trail of financial advice shared between financial advisors and clients. In this regard, interactions between financial advisors and users are often in-person or over the phone, which may result in financial advice shared by the financial advisor not being properly recorded and lead to regulatory compliance issues. Additionally, the ability for a financial advisory to inject actions or propose removal or modification of cations for a user introduces expert oversight into the financial planning process. To this extent, advisors can leverage their expertise and suggest personalized actions such as tax optimization strategies or investment opportunities, enhancing the collaborative planning between the user and advisor and offering a more nuanced and adaptive approach to reaching financial goals. Through the PAE system 102, financial advisors can proactively address financial needs, provide timely guidance in financial decisions, and integrate customized recommendations that align with the user.

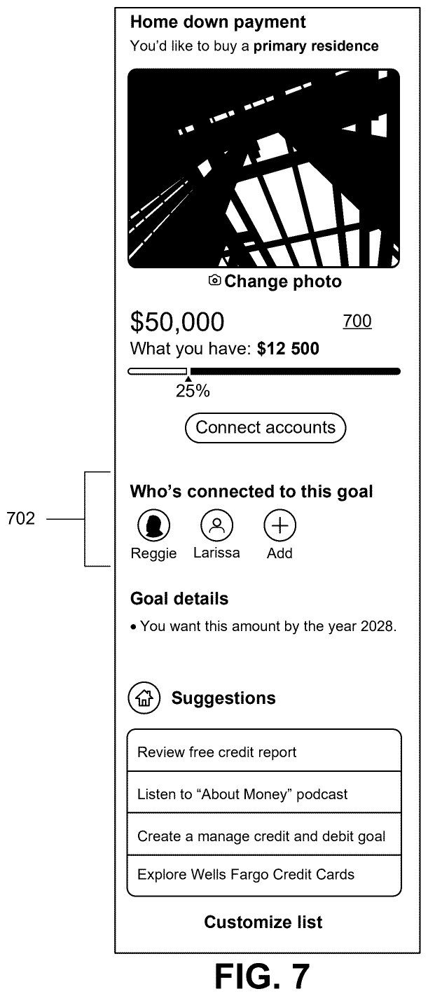

In some embodiments, a user may add a financial advisor as a collaborator to one or more goals through a process integrated via a GUI of the system application 112. For instance, users may search for and invite (via API requests) advisors on the platform to collaborate on one or more financial goals. In various embodiments, a user's GUI view 700 may reflect the collaboration status with a listing of collaborators 702, as shown for example in FIG. 7.

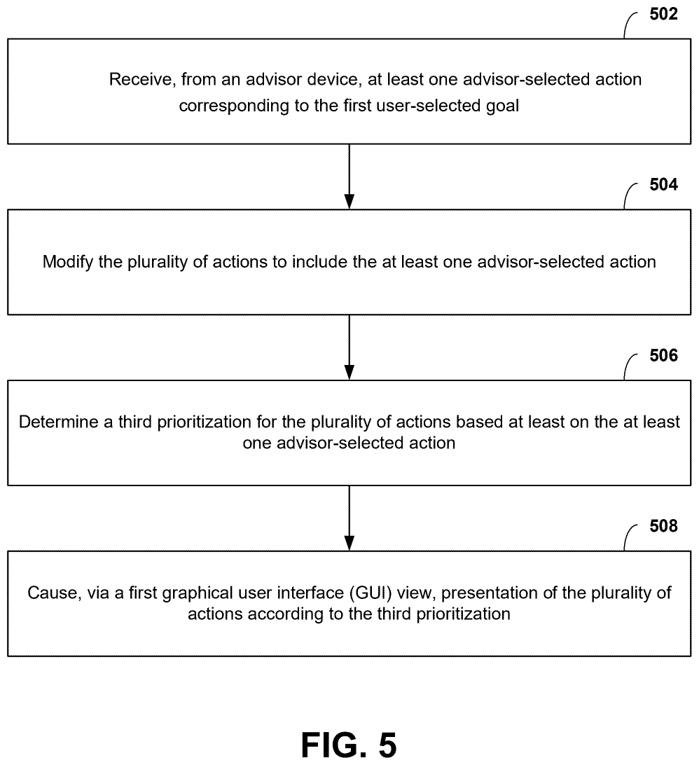

Turning to FIG. 5, example operations are shown for modifying prioritization of actions in response to at least one advisor-selected action.

As shown by operation 502, the apparatus 200 includes means, such as processor 202, memory 204, communications hardware 206, or the like, for receiving, by the communications hardware and from an advisor device, at least one advisor-selected action corresponding to the first user-selected goal.

In some embodiments, the PAE system 102 may enable advisors to access a user's action dataset and user dataset in order to integrate advisor-selected actions in service of one or more goals of the user. To do so, as mentioned above, an advisor may utilize an advisor device 108 to engage with an advisor-facing iteration of the PAE system application 112 designed to enable advisors to deliver tailored financial guidance and support to users. Upon review, an advisor may utilize one or more GUI views of the advisor-facing iteration of the PAE system application 112 to select one or more predefined actions to inject into the user's action dataset, generate tailored actions to inject into the user's action dataset, and/or generate notifications to present to the user via system application 112 regarding one or more actions of the user's action dataset.

In various embodiments, an advisor (through the advisor-facing iteration of the system application 112) may select a specific client to view their financial profile. By doing so, an API call is initiated to retrieve the user's most recent action dataset and user dataset. System application 112 may then parse the received payload containing the action dataset and user dataset and display the action dataset and/or user dataset in a structured format via a GUI view that includes, for example, filtering options, action progress, goal deadlines, and other information that aids the advisor in making informed decision with respect to adding actions in service of the client's goal(s). An advisor may then provide user input to create new actions or modifications directly through the system application 112's GUI interface. This may involve populating a template to add information describing a new action, define a priority level for the new action, and specify additional details regarding the action. The system application 112 may then send a request to an API endpoint of the PAE system 102 that includes the modifications made to the action dataset by the advisor. The request may then be received and validated by the PAE system 102, which may then update the action dataset. In this regard, as shown by operation 504, the apparatus 200 includes means, such as processor 202, memory 204, action mapping engine 208, or the like, for modifying, by the action mapping engine, the plurality of actions to include the at least one advisor-selected action.

As shown by operation 506, the apparatus 200 includes means, such as processor 202, memory 204, rules engine 210, or the like, for determining, by the rules engine, a third prioritization for the plurality of actions based at least on the at least one advisor-selected action. In this regard, based on modification data submitted by the advisor (e.g., how the advisor has added one or more actions, and/or suggested changes to or removal of one or more actions) the PAE system 102 may dynamically generate a new prioritization of actions. For example, the PAE system 102 may update the underlying user dataset and/or action dataset and synchronize these updates. In some embodiments, rules engine 210 may then process the updates to reassess the priority and relevance of the actions, which may involve determining and applying new weights to each action. In this manner, rules engine 210 may then determine a revised action list that is reordered to reflect current priorities of the user and includes one or more advisor-selected actions. The updated action list may then be transmitted back to the user device 106, which is then integrated into the GUI of system application 112. In this regard, as shown by operation 508, the apparatus 200 includes means, such as processor 202, memory 204, communications hardware 206, GUI engine 212, or the like, for causing, via the first GUI view, presentation of the plurality of actions according to the third prioritization.

FIGS. 3, 4, and 5 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, by communications hardware, a goal dataset comprising a plurality of user-selected goals including a first user-selected goal;
determining, by an action mapping engine, an action dataset comprising a plurality of actions to be performed by a user to achieve the first user-selected goal, wherein the plurality of actions are ranked according to a first prioritization;
determining, by a rules engine, a second prioritization for the plurality of actions based at least on a user dataset associated with the user; and
causing, by the communications hardware and via a first graphical user interface (GUI) view, presentation of the plurality of actions according to the second prioritization.

2. The method of claim 1, wherein determining the second prioritization for the plurality of actions is further based on a user-defined prioritization of the plurality of user-selected goals.

3. The method of claim 1, wherein the plurality of actions are presented via the first GUI view as interactive GUI elements.

4. The method of claim 3, further comprising:
receiving, by the communications hardware, a selection indication associated with a first interactive GUI element corresponding to a first action of the plurality of actions; and
dispositioning, by a GUI engine, the first GUI view in response to receiving the selection indication.

5. The method of claim 4,
wherein the selection indication corresponds to a completion of the first action, and
wherein dispositioning the first GUI view comprises:
modifying, by the GUI engine, the first interactive GUI element to visually indicate the completion of the first action.

6. The method of claim 4,
wherein the selection indication corresponds to a dismissal of the first action, and
wherein dispositioning the first GUI view comprises:
removing, by the GUI engine, the first interactive GUI element from the first GUI view.

7. The method of claim 4,
wherein the selection indication corresponds to a bookmarking of the first action, and
wherein dispositioning the first GUI view comprises:
modifying, by GUI engine, the first interactive GUI element to visually indicate the bookmarking of the first action.

8. The method of claim 4, further comprising:
determining, by the rules engine, a third prioritization for the plurality of actions based at least on the selection indication; and
causing, by the communications hardware and via the first GUI view, presentation of at least a portion of the plurality of actions according to the third prioritization.

9. The method of claim 4, wherein dispositioning the first GUI view comprises:
causing, by the communications hardware, presentation of a second GUI view including at least one of text, audio, or video regarding the first action of the plurality of actions.

10. The method of claim 1, further comprising:
receiving, by the communications hardware and from an advisor device, at least one advisor-selected action corresponding to the first user-selected goal;
modifying, by the action mapping engine, the plurality of actions to include the at least one advisor-selected action;
determining, by the rules engine, a third prioritization for the plurality of actions based at least on the at least one advisor-selected action; and
causing, by the communications hardware, presentation of the plurality of actions according to the third prioritization.

11. An apparatus comprising:
communications hardware configured to receive a goal dataset comprising a plurality of user-selected goals including a first user-selected goal;
an action mapping engine configured to determine an action dataset comprising a plurality of actions to be performed by a user to achieve the first user-selected goal, wherein the plurality of actions are ranked according to a first prioritization; and
a rules engine configured to determine a second prioritization for the plurality of actions based at least on a user dataset associated with the user,
wherein the communications hardware is further configured to cause, via a first graphical user interface (GUI) view, presentation of the plurality of actions according to the second prioritization.

12. The apparatus of claim 11, wherein the rules engine determines the second prioritization for the plurality of actions based further on a user-defined prioritization of the plurality of user-selected goals.

13. The apparatus of claim 11, wherein the plurality of actions are presented via the first GUI as interactive GUI elements.

14. The apparatus of claim 13,
wherein the communications hardware is further configured to receive a selection indication associated with a first interactive GUI element corresponding to a first action of the plurality of actions, and
wherein the apparatus further comprises a GUI engine configured to disposition the first GUI view in response to receiving the selection indication.

15. The apparatus of claim 14,
wherein the selection indication corresponds to a completion of the first action, and
wherein the GUI engine dispositions the first GUI view by modifying the first interactive GUI element to visually indicate the completion of the first action.

16. The apparatus of claim 14,
wherein the selection indication corresponds to a dismissal of the first action, and
wherein the GUI engine dispositions the first GUI view by removing the first interactive GUI element from the first GUI view.

17. The apparatus of claim 14,
wherein the selection indication corresponds to a bookmarking of the first action, and
wherein the GUI engine dispositions the first GUI view by modifying the first interactive GUI element to visually indicate the bookmarking of the first action.

18. The apparatus of claim 14,
wherein the rules engine is further configured to determine a third prioritization for the plurality of actions based at least on the selection indication, and
wherein the communications hardware is further configured to cause, via the first GUI view, presentation of at least a portion of the plurality of actions according to the third prioritization.

19. The apparatus of claim 11,
wherein the communications hardware is further configured to receive, from an advisor device, at least one advisor-selected action corresponding to the first user-selected goal,
wherein the action mapping engine is further configured to modify the plurality of actions to include the at least one advisor-selected action;
wherein the rules engine is further configured to determine third prioritization for the plurality of actions based at least on the at least one advisor-selected action, and
wherein the communications hardware is further configured to cause presentation of the plurality of actions according to the third prioritization.

20. A computer program product comprising at least one non-transitory computer-readable storage medium storing software instructions that, when executed, cause an apparatus to:
receive a goal dataset comprising a plurality of user-selected goals including a first user-selected goal;
determine an action dataset comprising a plurality of actions to be performed by a user to achieve the first user-selected goal, wherein the plurality of actions are ranked according to a first prioritization;
determine a second prioritization for the plurality of actions based at least on a user dataset associated with the user; and
cause, via a first graphical user interface (GUI) view, presentation of the plurality of actions according to the second prioritization.
